(19) United States
(12) Patent Application Publication
(10) Pub. No.: US 2025/0009179 A1
(43) Pub. Date: Jan. 9, 2025

(54) BARBECUE OR COOKER

(71) Applicant: LOTUSGRILL GMBH, Limburgerhof (DE)

(72) Inventors: Mischa OHLER, Otterstadt (DE); Harri PAAKKANEN, Heidelberg (DE)

(21) Appl. No.: 18/708,372

(22) PCT Filed: Aug. 17, 2022
(86) PCT No.: PCT/DE2022/200187

§ 371 Date: May 8, 2024

(30) Foreign Application Priority Data
Nov. 9, 2021 (DE) 10 2021 212 606.5

(51) Int. Cl. A47J 37/07

(52) U.S. Cl. CPC A47J 37/0763; A47J 37/0754

(57) ABSTRACT

The invention relates to a barbecue, cooker, or the like, having an outer shell which serves as a housing (1); a support shell (2) arranged inside the outer shell and being distanced therefrom on all sides; a burner unit located inside the support shell (2); a barbecue grate (3) or container arranged above the burner unit; and a gas supply device which generates a fluid flow toward or into the burner unit from below the support shell (2), characterized in that a wood charcoal burner unit or a gas burner unit, together with specific attachment elements, can optionally be used as the burner unit, wherein, when the burner unit is used accordingly, a directed air flow can be conducted into or toward the wood charcoal burner unit or flammable gas can be conducted into or toward the gas burner unit via the gas supply device.

### CROSS REFERENCE TO RELATED APPLICATIONS

This application is a National Stage Application, filed under 35 U.S.C. § 371, of International Application No. PCT/DE2022/200187, filed Aug. 17, 2022, which international application claims priority to and the benefit of German Application No. 10 2021 212 606.5, filed Nov. 9, 2021; the contents of both of which as are hereby incorporated by reference in their entireties.

### BACKGROUND

### Technical Field

The invention relates to a barbecue, cooker, or the like. For the sake of simplicity, the term barbecue will be used in most cases below, wherein this can be a tabletop barbecue for positioning on a table or a standing barbecue for positioning on a floor or the like.

The barbecue comprises an outer shell which serves as a housing; a support shell arranged inside the outer shell and being distanced therefrom on all sides; a burner unit located inside the support shell; a barbecue grate and/or container arranged above the burner unit for cooking and grilling; and a gas supply device which generates a fluid flow toward or into the burner unit from below the support shell.

### Description of Related Art

Regarding the prior art, reference is made, merely by way of example, to EP 1 838 187 B1 and EP 2 785 227 B1. This publication discloses a wood charcoal barbecue, according to which the burner unit is designed as a wood charcoal burner chamber.

For the known charcoal barbecue, it is essential that it comprises a wood charcoal burner chamber inside a housing, wherein the wood charcoal burner chamber is closed by a lid during operation. The lid can be solid or perforated. A stepped perforated design of the lid is also known. The charcoal burner chamber stands on an ignition shell and can be supplied with outside air from below the ignition shell, which promotes the ignition process using an ignition paste and also the burning off of the wood charcoal.

From practice, a wide variety of designs of the wood charcoal burner chamber are known, in particular with differently designed walls. A perforation or slit of the wall should favor the heat radiation to the side and ultimately also toward the barbecue grate.

The well-known wood charcoal barbecue has proven itself in practice. If the wood charcoal burner chamber is safely positioned there, i.e., in a non-tilting manner in the housing, the barbecue offers a considerable level of safety. It has also been shown that a low-smoke operation of the barbecue is possible using suitable charcoal, for example from LotusGrill GmbH. The actual smoke development thus depends predominantly on the food to be grilled.

Recently, for example, grilling bans have been issued more and more frequently in parks or public green spaces with regard to the use of charcoal. Fire hazard, increasing pollution of the environment, and supposedly stronger CO₂ emissions of a wood charcoal barbecue compared to an electric barbecue or gas barbecue are given as the justification. Often, picnic enthusiasts are not confronted with the local requirements/orders or bans until they are on site, often to the effect that the use of otherwise popular charcoal grills is not permitted. A barbecue with an alternative firing/heating medium, for example a gas barbecue or an electric barbecue, is regularly not available. An electric barbecue is hardly an option, anyway, namely in the absence of a power attachment or a sufficiently powerful battery.

### BRIEF SUMMARY

The invention addresses the problem of designing and further developing a conventional barbecue, cooker, or the like in such a way that it can be operated in a proven manner with charcoal but also with gas, and at the same time meets the legal provisions. The barbecue, cooker, etc. should be simple in design and user-friendly. Moreover, it should distinguish itself from competitive products.

The above task is solved by a barbecue, cooker, or the like having the features of the presented independent claim(s). Accordingly, the generic barbecue, cooker, or the like is characterized in that a wood charcoal burner unit or a gas burner unit, if applicable together with specific attachment elements, can optionally be used as the burner unit, wherein, when the burner unit is used accordingly, a directed air flow can be conducted into or toward the wood charcoal burner unit or flammable gas can be conducted into or toward the gas burner unit via the gas supply device.

According to the invention, it has been found that, for example, the barbecue known from EP 2 785 227 B1 is particularly suitable for universal use, namely when two different burner units are available for the operation of the barbecue, namely a more or less conventional charcoal burner unit and a gas burner unit, which can be exchanged for one another with little effort. This means that specific attachment elements are to be exchanged with the respective burner unit, so that the burner unit functions correctly with the respective fuel.

According to the burner unit used (conventional charcoal burner unit or gas burner unit), it can be supplied as is customary with a fluid via the gas supply device, specifically in such a way that, in the case of the wood charcoal burner unit, a directed air flow and, in the case of the gas burner unit, a flammable gas can be conducted into the burner unit.

For the function of the system relating to the use of the wood charcoal burner unit, reference is made to EP 2 785 227 B1, the contents of which are hereby added to the disclosure of the present invention.

The barbecue or cooker according to the invention is an autonomous device, which comprises two different burner units intended for exchange, wherein the exchange can be carried out manually, preferably without tools. Depending on the need, a choice can be made between using it as a wood charcoal barbecue or as a gas barbecue, which results in an enormous flexibility of the barbecue or cooker. It is therefore a hybrid barbecue.

The charcoal burner chamber comprises a housing in order to house the charcoal. The housing can be designed in a variety of ways. It is preferably perforated or slitted, so that optimal heat dissipation results during operation.

The floor of the housing can be offset inwardly, so that the wall projects downwards beyond the floor and a type of cavity is formed below the actual burner chamber. The floor is perforated so that the air required for ignition and burning can flow through the floor into the housing to the wood charcoal.

The housing stands with its lower edge region on or in an ignition shell, into which an ignition paste or the like is placed before ignition. The ignition shell is positioned centrally in the support shell, wherein an air pipe projects through the ignition shell into the airbox formed between the floor of the wood charcoal burner chamber and the ignition shell. This space is supplied with air via an electrical ventilator arranged in the floor region of the outer shell, wherein the ventilator can be controlled with respect to the air volume to be conveyed or can be regulated with respect to the heat to be generated.

Regarding further function and design, reference is made in full to EP 2 785 227 B1.

The charcoal burner chamber comprises a preferably perforated lid, which forces the hot air generated by the burning through the wall of the wood charcoal burner chamber radially outwards. In addition, the wood charcoal burner chamber can be fixed between the barbecue grate and the support shell, namely by bracing the barbecue grate, due to the lid, if applicable using a lifting eye centrally attached there. This ensures that the wood charcoal burner chamber is positioned securely, which promotes the safe operation of the barbecue.

As already stated, the barbecue, cooker, or the like according to the invention is equipped with an exchange system, namely it comprises a further burner unit, which is designed as a gas burner chamber in the sense of a closed unit. The burner chamber of the gas burner unit is outfitted similar to the burner chamber of the wood charcoal burner unit. A preferably perforated or slitted housing is thus also provided there. Here, too, radial heat radiation should be favored.

The gas burner chamber has a floor that can be offset inwardly, as in the case of the wood charcoal burner chamber. However, this is not absolutely necessary.

Near the floor, a gas burner is arranged in the center of the housing, such as the ones used for camping cookers, for example. The gas burner sits on a gas rising pipe, which extends through the floor of the gas burner chamber below and thus outside the gas burner chamber to an inner gas attachment device. The inner gas attachment device is fluidly connected via an inner gas line to an outer gas attachment device for the direct or indirect attachment of a gas cylinder or the like. All gas connections are designed so as to be gas-tight and have corresponding sealing means.

The gas rising pipe is equipped outside the gas burner chamber, preferably in the lower region, with an air inlet, which is defined by a bore or whose flow cross-section is changeable, in order to mix outside air into the burner gas, for example butane or propane, and thus influence the burning of the gas or the flame.

In addition, it is advantageous to be able to influence the flow cross-section for the inflowing gas, wherever that may be, in order to be able to adjust the flame and thus the barbecue temperature.

In a further advantageous manner, an opening for the insertion of an ignition means is formed in the wall of the gas burner chamber, approximately at the level of the gas burner or slightly above it. In the simplest case, the outflowing gas can be ignited by a match or a long lighter. It is also conceivable for a piezo lighter to protrude into the gas burner chamber and be fixedly attached there. In any case, it is conceivable that the ignition means works electrically or mechanically or in a combined manner.

As with the wood charcoal burner chamber, it is also necessary for the gas burner chamber to sit securely inside the support shell. For this purpose, the gas burner chamber can comprise a lower pedestal, or a separate pedestal can be provided, on which the gas burner chamber sits. The pedestal is used for the secure positioning of the gas burner chamber on the support shell, wherein individual feet or a ring-shaped closed standing foot can be configured for this purpose. The secure standing is also ensured by the positioning and screwing of the gas rising pipe, which can be supported on the support shell, an intermediate plate, and on a floor plate. It is also conceivable that the gas rising pipe is supported and guided/held between the gas burner chamber and the inner gas attachment device by a sleeve.

In a further advantageous manner, the gas burner chamber comprises a lid, which is preferably perforated and is fixedly connected to the housing of the burner chamber, via which the gas burner chamber can be fixed in a non-slipping manner between the barbecue grate and the support shell. This measure corresponds to the fixing of the wood charcoal burner chamber, with the same advantages.

The exemplary embodiment discussed above relates to the use of a gas burner chamber for grilling. This means that a lockable or braceable barbecue grate is provided above the gas burner chamber, as with the wood charcoal burner chamber. A type of railing can be provided for circumferential securing of the food to be grilled. The barbecue rack and railing can be designed in one piece.

In the context of a further embodiment of the cooker according to the invention, it is conceivable that the gas burner unit comprises, in addition to the gas burner, a preferably circumferential or sectionally configured standing base for positioning a container, for example for positioning a pot, a pan, or the like, above the gas burner. In this case, the gas burner is arranged under the level of the standing base, wherein, as in the previously described exemplary embodiment of the gas burner, a gas rising pipe extends downward through the standing base and the support shell to an inner gas attachment device, which is fluidly connected to an outer gas attachment device for the direct or indirect attachment of a gas cylinder or the like. Here, the same designs apply as for the previously mentioned exemplary embodiment with a gas burner chamber and barbecue grate. It is also advantageous when, in the embodiment in question here, the gas burner unit comprises a support device, with which the gas burner unit is positioned in the support shell in a supporting manner, particularly in view of the fact that a filled cooking pot, for example, is to be positioned and held by the standing base. Accordingly, the support device serves to stiffen and stabilize the arrangement, wherein the gas burner is held via the gas rising pipe, if necessary a false floor, and the inner gas attachment device. A secure standing is guaranteed in the connected and, if applicable, screwed state of the gas burner with the gas rising pipe.

In the floor region of the outer shell, an exchange mechanism is arranged below the support shell, preferably on a floor plate, which can be actuated when the burner chamber is removed. Upon its actuation, after reaching a defined working position for the respective burner device, an insertion and activation, including the specific attachment elements, is possible. This means that when the burner chamber is removed, the type of burner chamber to be used (wood charcoal burner chamber or gas burner chamber) can be selected by actuating the exchange mechanism, namely by reaching a defined working position for the respective burner chamber.

The exchange mechanism can be designed in a variety of ways. The exchange mechanism preferably comprises a sliding device, which can be slid or pivoted, by actuation from laterally outside or below the housing, from a position so as to receive/activate the wood charcoal burner chamber into a position so as to receive/activate the gas burner chamber. The position set by the sliding device can be identified by a display element from outside or below the housing by means of corresponding markings.

Specifically, the sliding device comprises a slider, which, in the position for attachment of the wood charcoal burner unit, supports an air attachment unit comprising the fan and an airbox up to an insertion opening of the air inlet pipe. In the position for attachment of the gas burner unit, the slider comprises a gas-sealing screw or plug attachment for the gas rising pipe with an inner gas attachment and a fluid connection to the outer gas attachment. According to the position of the slider, a simple insertion and thus a simple attachment of either the wood charcoal burner chamber or the gas burner chamber is possible, in the case of the wood charcoal burner chamber with quasi-automatic attachment of the air supply and in the case of the gas burner chamber with quasi-automatic attachment of the supply of the gas burner with combustible gas.

For easy handling of the barbecue or cooker according to the invention, it is advantageous when the exchange mechanism has a latching or locking for the respective operating position. The user thus gains the feeling of a proper setting, in each case after latching, and, for “switching” to the respective other position, a certain force is required for disengaging and re-latching into the respective other position.

Finally, it is particularly advantageous when the outer gas attachment device is automatically or forcedly blocked in the position of the exchange mechanism when it receives/activates the wood charcoal burner chamber. Here, it should be avoided that gas is conducted into the interior of the housing when the wood charcoal burner chamber is connected. The blocking can be performed mechanically via the sliding device or via a separate closure device, in the simplest case by blocking the attachment bushing for insertion/screwing in the gas attachment line from outside to the housing. Only when the exchange mechanism is in the position for inserting the gas burner unit is the outer gas attachment released and, for example, a flexible gas line with conventional attachment means can be plugged and screwed into a gas attachment bushing in a sealing manner.

### BRIEF DESCRIPTION OF THE FIGURES

There are various ways to advantageously configure and further develop the teaching of the present invention. For this purpose, reference is hereby made on the one hand to the dependent claims, and on the other hand to the following explanation of preferred embodiments of the invention with reference to the drawings. In attachment with the discussion of preferred exemplary embodiments of the invention on the basis of the drawing, generally preferred configurations and further developments of the teaching are discussed as well. The drawings show:

FIG. 1 in a schematic exploded view, the essential “outer” components of the barbecue according to the invention, without a view of the specific burner chamber,

FIG. 2 in a schematic view, partially sectioned, the barbecue according to the invention with the inserted charcoal burner chamber,

FIG. 3 in a schematic view, partially sectioned, the barbecue according to the invention with the inserted gas burner chamber used,

FIG. 4 in a schematic view, partially sectioned, an exemplary embodiment of a cooker according to the invention with the inserted gas burner,

FIG. 5 in a schematic view, from the outside and in detail from the inside, the outer gas attachment with the inner blocking device in the opened state,

FIG. 6 in a schematic view, from the outside and in detail from the inside, the outer gas attachment with the inner blocking device in the blocked state.

### DETAILED DESCRIPTION OF VARIOUS EMBODIMENTS

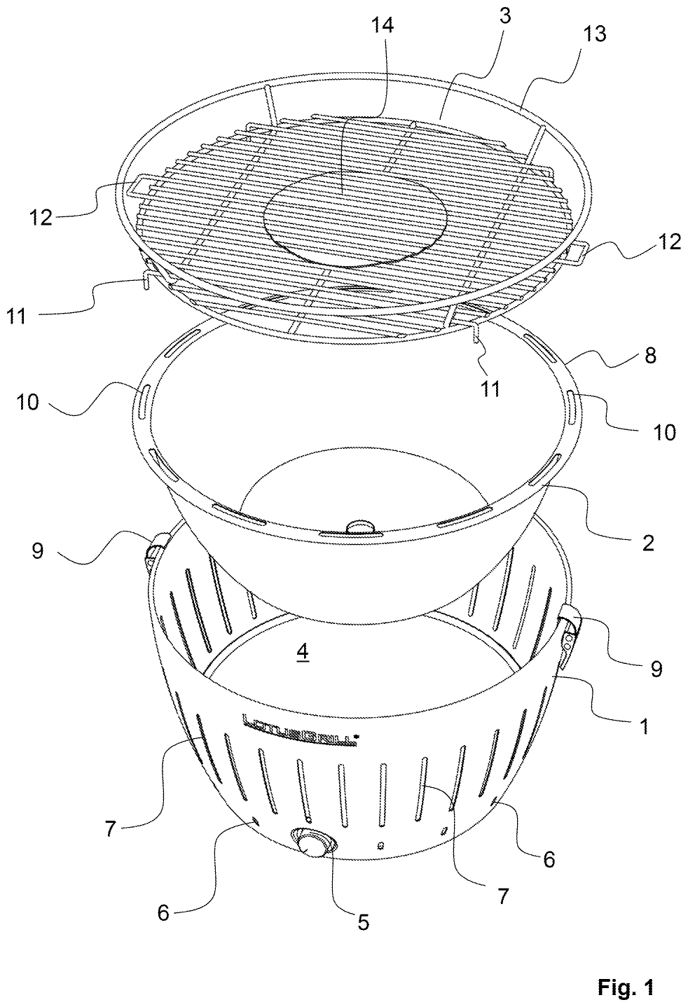

FIG. 1 shows, in a schematic exploded view, the “outer” components of the barbecue according to the invention, namely, starting from below, the housing 1, the support shell 2 that can be inserted into the housing 1, and the barbecue grate 3 that can be arranged above.

Furthermore, FIG. 1 shows that the housing 1 comprises an inner floor 4 in the lower region in the sense of a false floor, under which or on which electrical and, if applicable, mechanical components can be arranged. From outside the housing 1, a rotary knob 5 can be seen which is used in order to switch on and off and to regulate a fan arranged under the inner floor 4.

Lower passages 6 are provided in the wall of the housing 1, which serve to suck in outside air. Upper passages 7 serve to rear-ventilate the space between the support shell 2 and the housing 1.

The support shell 2 is placed on the free edge of the housing 1 with its edge region 8 and is fixed there by means of bracing apparatuses 9, which engage on the barbecue grate 3. The bracing apparatuses 9 are ultimately clamps that engage on both sides and fixedly connect the barbecue grate 3 and thus also the support shell 2 to the housing 1.

Recesses 10 are provided in the edge region 8 of the support shell 2, which serve for the insertion of feet 11 of the barbecue grate 3 in a positioning manner. This measure allows the barbecue grate 3 to be positioned in an ideal manner, wherein the bracing apparatuses 9 or the bracing clips provided there engage into lateral fastening lugs 12 on the barbecue grate 3. With the bracing of the bracing apparatuses 9, the barbecue grate 3 is fixedly connected to the housing 1, namely with the interposition of the support shell 2, which is fixed in the same way. In the assembled position, a heat-insulating airbox is created between the housing 1 and the support shell 2 and is rear-ventilated via the upper passages 7. The recesses 10 in the upper edge region of the support shell 2 are used, on the one hand, for the insertion of feet 11 of the barbecue grate 3 and, on the other hand, for the escape of warm/hot air from the interior of the housing 1, more precisely from the region between the housing 1 and the support shell 2. The recesses 10 thus facilitate the rear ventilation.

The barbecue grate 3 comprises a circumferential railing 13 and is equipped in the center with a closed, corrugated barbecue surface 14, whose edge region can be designed so as to drip grease such that it falls at least slightly downwards.

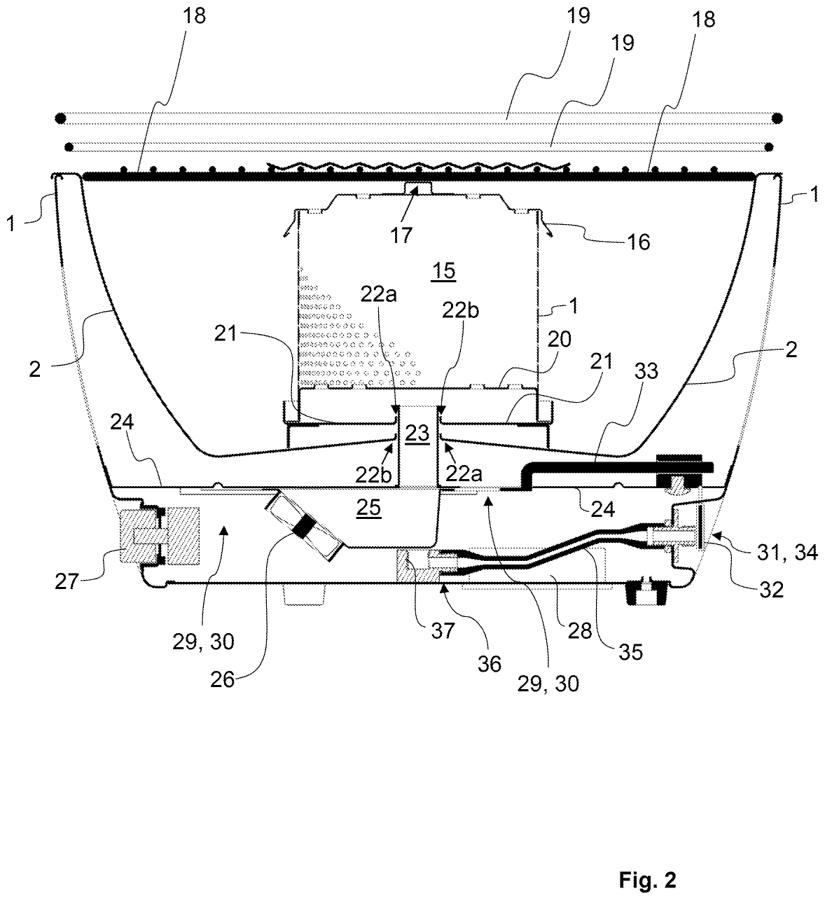

FIG. 2 shows the barbecue according to the invention with the inserted wood charcoal burner chamber 15. The charcoal burner chamber 15 has a perforated wall and is closed with a lid 16. The lid 16 is equipped with a lifting eye 17, which serves for the attachment on a barbecue grate 18 from below. Above the barbecue grate 18, a double railing 19 is provided for lateral securing of the food to be grilled.

The charcoal burner chamber 15 has a perforated floor 20, wherein the perforation serves for the inflow of outside air into the interior of the wood charcoal burner chamber.

Furthermore, an ignition shell 21 is provided underneath the wood charcoal burner chamber 15 and can be coated with an ignition paste. The charcoal burner chamber 15 stands with its lower edge in the ignition shell 21 and remains there in a more or less non-slipping manner.

A passage 22a is provided centrally in the ignition shell 21, through which an air inlet pipe 23 extends through the support shell 2 to a false floor 24. A passage 22b is also provided in the false floor 24, after which the false floor 24 opens into an airbox 25, which is supplied with outside air via a ventilator 26. In other words, the ignition shell 21 and the support shell 2 are stuck onto the air inlet pipe 23, i.e., around it. The false floor 24 opens in an airbox 25, which is supplied with outside air via a ventilator 26. The ventilator 26 can be operated via a switch 27 from outside the housing 1. For power supply, batteries are provided in a battery compartment 28.

FIG. 2 also shows the provision of a sliding device 29, via which a slider 30 can be displaced. In the state shown in FIG. 2, the slider 30 is in the position so as to release the air flow from the airbox 25 to the air inlet pipe 23. The outer gas attachment device 31 is blocked [by] a blocking element 32, wherein the blocking element 32 is brought into the blocking position according to FIG. 2 by manual actuation, for example. The rod 33 is used for actuation or displacement of the sliding device 29 or the slider 30.

With respect to the gas attachment shown in FIG. 2, which is not activated by the sliding apparatus 29, FIG. 2 shows the outer gas attachment device 31 in the state when blocked by the blocking element 32, the outer gas attachment 34, an inner gas attachment line 35, and an inner gas attachment 36, which, shown angled or rotated by 90°, comprises an inner threading 37 for inserting and screwing in a gas rising pipe, which is not shown in FIG. 2.

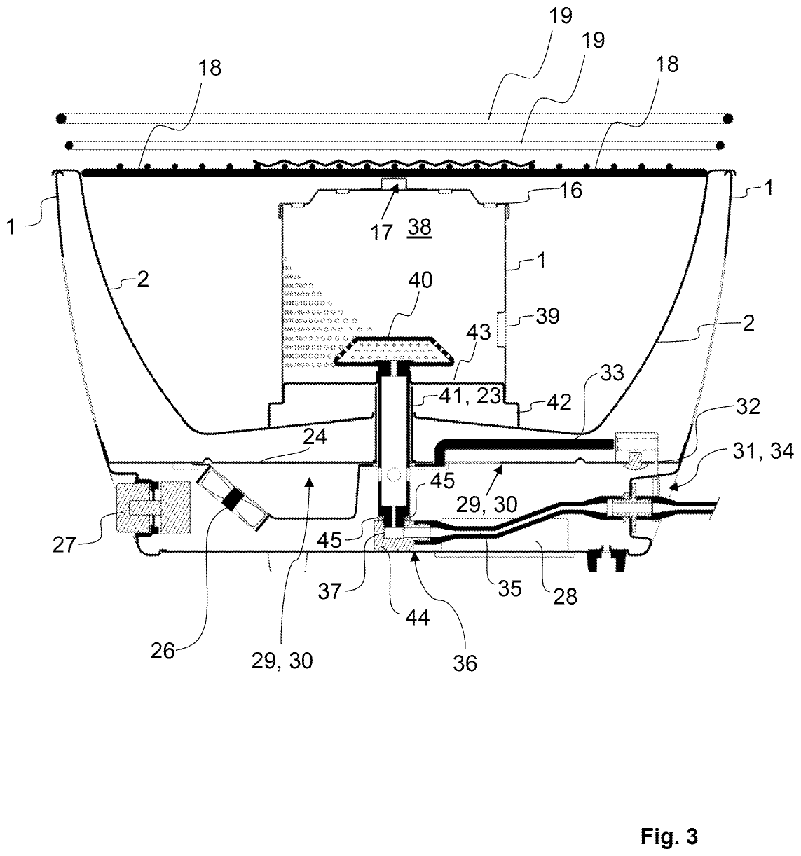

FIG. 3 shows the barbecue according to the invention with the inserted gas burner chamber 38. Like the wood charcoal burner chamber, the gas burner chamber 38 comprises a perforated housing 1 having a lid 16 stuck onto it, wherein the lid 16 is fixedly connected to the housing 1. Above the lid 16 or above a lifting eye 17, the barbecue grate 18 is arranged with the railing 19, as a result of which the gas burner chamber 38 is secured.

Furthermore, the gas burner chamber 38 comprises an opening 39 in the lower region, through which the gas can be ignited from outside.

A gas burner 40, which is supplied with gas via a gas rising pipe 41, is arranged inside the gas burner chamber 38. The connection between the gas rising pipe 41 and the gas burner 40 is designed so as to be gas-tight.

According to the view in FIG. 3, the gas burner chamber 38 stands on the support shell 2 and is positioned there by means of a support device 42. The support device 42 can be an integral component of the gas burner chamber 38, in particular of the floor 43 which is inwardly offset there.

The gas rising pipe 41 extends from the gas burner 40 through the floor 43 of the gas burner chamber 38, through a central passage in the support shell 2, and through a false floor 24, which comprises or supports the sliding device 29. The sliding device 29 or slider 30 is located in the position which serves the attachment of the gas burner chamber 38, so that the gas rising pipe 41 can be screwed into an attachment block 44 of the inner gas attachment 36. Suitable sealing means 45 can be interposed.

From outside the housing 1, i.e., via an outer gas attachment device 31, the gas coming from a gas tank, for example a cartridge, a gas cartridge, etc., can flow in, if applicable with the interposition of a regulator, and reaches the gas burner 40 via the provided flow path.

FIG. 3 further shows that the blocking element 32 is in the opened position. Using the rod 33, the slider 30 or blocking device 29 is brought into the position that is suitable for attachment of the gas burner chamber 38. In this position, the air inlet pipe 23 serves as the gas rising pipe 41.

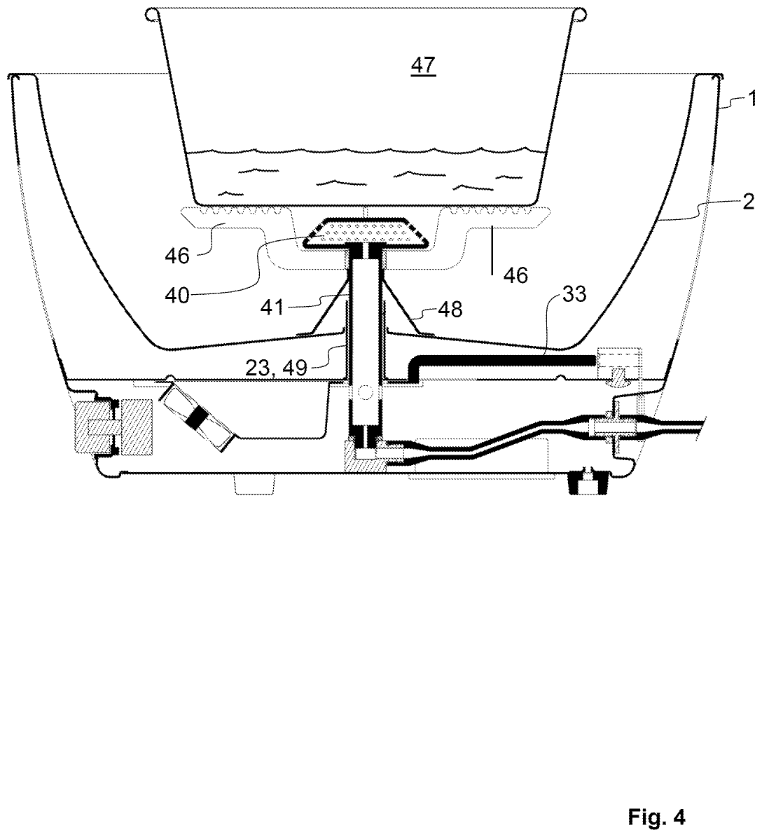

FIG. 4 shows a further exemplary embodiment with the inserted gas burner 40, without the provision of a gas burner chamber.

A standing base 46 is provided around the gas burner 40, which base can comprise individual standing base elements, for example designed in a finger-like manner. The standing base 46 serves to position a pot 47. In the middle of the region of the standing base 46, the gas burner 40 is arranged so that it lies lower, and is in turn supported by a gas rising pipe 41. A separate support element 48, which can be fastened directly to the gas rising pipe 41 or to a sleeve 49 surrounding the gas rising pipe 41, is provided for stabilization in relation to the support shell 2.

With regard to the connection to an external gas supply or to a gas storage unit as well as with regard to the flow path of the gas and finally also with regard to the function of the sliding device, reference is made to the figure description of FIG. 3 in order to avoid repetitions.

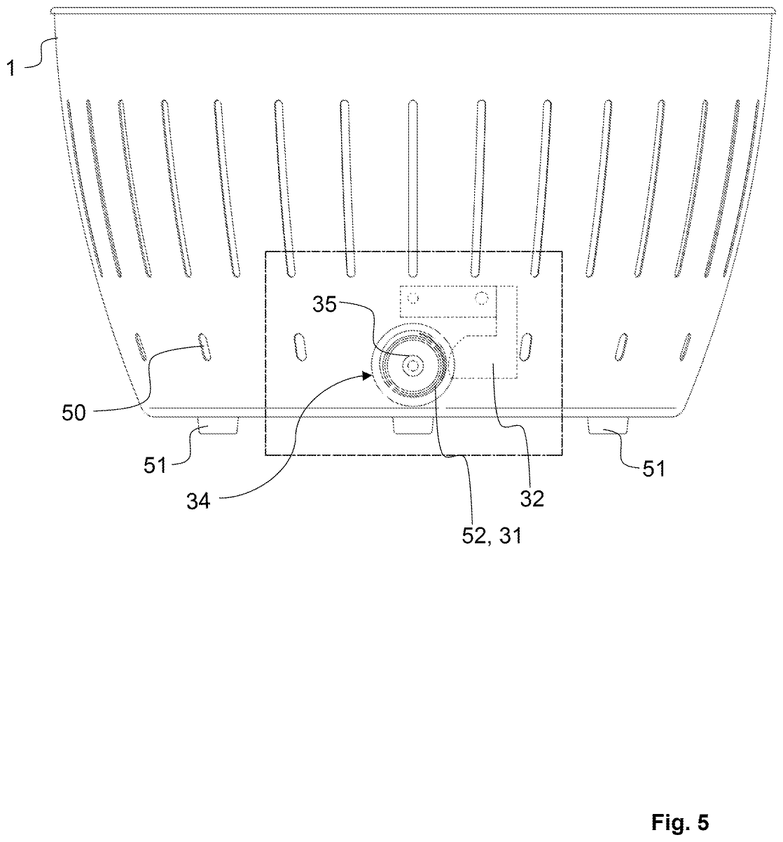

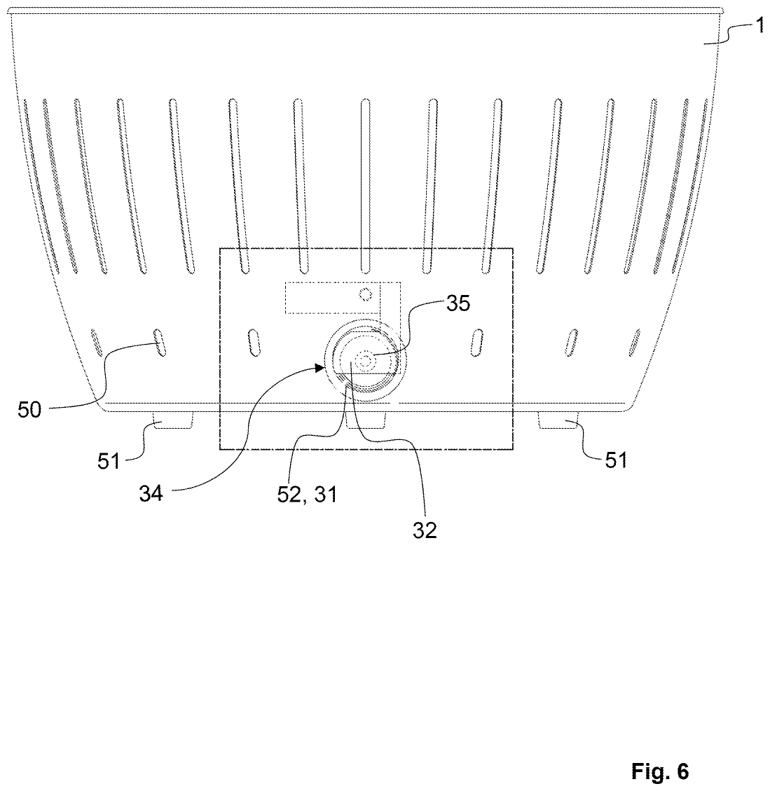

FIGS. 5 and 6 partially show an outer view of the housing 1 with ventilation slits 50. The housing 1 is positioned on standing knobs 51. These can be at least partially height-adjustable.

FIGS. 5 and 6 show, from outside the housing 1, the outer gas attachment 34 with a gas attachment bushing 52 for inserting in a latching manner or screwing in a conventional gas attachment with a gas attachment line. According to the view in FIG. 5, due to the slider position (not shown), the blocking element 32 is remote from the insertion region. The gas attachment bushing 52 is thus free, and an outer gas attachment element can be plugged in.

By contrast, FIG. 6 shows the gas attachment bushing 52 in the blocked state, after which the outer gas attachment device 31 is closed via the blocking element 32.

With respect to further advantageous configurations of the apparatus according to the invention, reference is made to the general part of the description and to the attached claims in order to avoid repetitions.

Finally, explicit reference is made to the fact that the exemplary embodiments of the apparatus according to the invention described above are used only for explanation of the claimed teaching, but the teaching is not restricted to the exemplary embodiments.

1-15. (canceled)

16. A barbecue, cooker, or the like, comprising:
an outer shell which serves as a housing (1);
a support shell (2) arranged inside the outer shell and being distanced therefrom on all sides; a burner unit located inside the support shell (2);
a barbecue grate (3) or container arranged above the burner unit; and
a gas supply de-vice which generates a fluid flow toward or into the burner unit from below the support shell (2),
wherein:
a wood charcoal burner unit or a gas burner unit, together with specific attachment elements, can be used as the burner unit, and
when the burner unit is used accordingly, a directed air flow can be conducted into or toward the wood charcoal burner unit or flammable gas can be conducted into or toward the gas burner unit via the gas supply device.

17. The barbecue according to claim 16, wherein:
the burner unit is designed as a wood charcoal burner chamber (15) and comprises a perforated or slitted housing (1) and a perforated floor which is offset inwardly,
the housing (1) stands with a lower edge region on or in an ignition shell (21),
the ignition shell (21) is positioned centrally in the support shell (2), and
an air inlet pipe (23) projects centrally through the ignition shell (21) into an ignition and airbox formed between the floor of the wood charcoal burner chamber (15) and the ignition shell (21), which pipe is supplied with air via an electric ventilator (26) arranged in the floor region of the outer shell.

18. The barbecue according to claim 17, wherein the wood charcoal burner chamber (15) comprises a perforated lid (16), via which the wood charcoal burner chamber (15) can be fixed in a non-slipping manner between the barbecue grate (3) and the support shell (2) by bracing the barbecue grate (3).

19. The barbecue according to claim 16, wherein burner unit is designed as a gas burner chamber (38) in the sense of a closed unit having a perforated or slitted housing (1), a floor, and a gas burner (40) arranged centrally on the floor in the housing (1), from which burner a gas rising pipe (41) extends through the floor to an inner gas attachment device (36) outside the gas burner chamber (38), which device is fluidly connected to an outer gas attachment device (34) for the direct or indirect attachment of a gas cylinder or the like.

20. The barbecue according to claim 19, wherein an opening for introducing an ignition means is configured in the wall of the gas burner chamber (38), approximately at the level of the gas burner (40).

21. The barbecue according to claim 20, wherein the ignition means is designed as an electrically or mechanically operating ignition means.

22. The barbecue according to claim 19, wherein the gas burner chamber (38) sits on a pedestal designed for the secure positioning of the gas burner chamber (38) on the support shell (2).

23. The barbecue according to claim 19, wherein the gas burner chamber (38) comprises a lid (16), which is fixedly attached to the burner chamber and perforated, via which the gas burner chamber (38) can be fixed in a non-slipping manner between the barbecue grate (3) and the support shell (2).

24. The barbecue according to claim 16, wherein:
the gas burner unit comprises a gas burner and a circumferential standing base for positioning a container,
the gas burner is arranged below the level of the standing base,
a gas rising pipe (41) extends through the standing base and the support shell to an inner gas attachment device, which device is fluidly connected to an outer gas attachment device for the direct or indirect attachment of a gas cylinder or the like.

25. The barbecue according to claim 24, wherein the container is a pot or a shell.

26. The barbecue according to claim 24, wherein the gas burner unit comprises a support device (42) with which the gas burner unit can be positioned in the support shell (2) in a supporting manner.

27. The barbecue according to claim 16, wherein, in the floor region of the outer shell, under the support shell (2), an exchange mechanism is arranged, which can only be actuated when the burner chamber is removed, and, upon the actuation thereof, after reaching a defined working position for the respective burner device, an insertion and activation of the respective burner chamber, including the specific attachment elements, is possible.

28. The barbecue according to claim 27, wherein the exchange mechanism is arranged on a floor plate.

29. The barbecue according to claim 27, wherein the exchange mechanism comprises a sliding device (29), which can be slid or pivoted, by actuation from inside, laterally outside, or below the housing (1), from a position to receive and/or activate the wood charcoal burner chamber (15) into a position so as to receive/activate the gas burner chamber (38).

30. The barbecue according to claim 29, wherein the sliding device (29) comprises a slider, which, in the position for attachment of the wood charcoal burner unit, supports an air attachment unit comprising the fan and an airbox up to an insertion opening of the air inlet pipe and, in the position for attachment of the gas burner unit, comprises a gas-sealing screw or plug attachment for the gas rising pipe (40) with an inner gas attachment and a fluid connection to the outer gas attachment.

31. The barbecue according to claim 27, wherein the exchange mechanism comprises a latching or locking for the respective operating position.

32. The barbecue according to claim 27, wherein, in the position of the exchange mechanism so as to receive and/or activate the wood charcoal burner chamber (15), the outer gas attachment device is automatically blocked via the sliding device (29) or via a separate closure device.

33. The barbecue according to claim 32, wherein the outer gas attachment device is mechanically blocked.
